(19) United States
(12) Patent Application Publication
(10) Pub. No.: US 2024/0390831 A1
(43) Pub. Date: Nov. 28, 2024

(54) AIR FILTER ADAPTER FRAME

(71) Applicant: Kevin Bunce, Post Falls, ID (US)

(72) Inventor: Kevin Bunce, Post Falls, ID (US)

(21) Appl. No.: 18/673,240

(22) Filed: May 23, 2024

Related U.S. Application Data
(60) Provisional application No. 63/468,933, filed on May 25, 2023.

(51) Int. Cl. B01D 46/00

(52) U.S. Cl. CPC B01D 46/0005

(57) ABSTRACT

An air filter adapter includes a frame portion and a flange that extends at least partially from an inner perimeter of the frame portion. The frame portion has a first pair of opposite sides each having a first length and a first width and a second pair of opposite sides each having a second length and a second width. The flange extends at least partially from an inner perimeter of the frame portion towards a center of the frame portion such that an air filter is supported by the frame portion about a perimeter thereof and rests against the flange on a first side.

### RELATED APPLICATIONS

This application claims priority to U.S. Provisional Application No. 63/468,933, filed on May 25, 2023, the entire contents of which are incorporated herein by reference.

### BACKGROUND

The disclosure herein relates to air filtration. Air filters vary in size drastically between different uses, industries, and machines within the same industry. Generally, there are manufacturers for the air filters that fit in each system in which they are used. However, frequently, the air filter technology required for the particular use of the filter is not proprietary. The specific size of the filters used for any given purpose may only be manufactured by a single manufacturer, and as such, the price of the filters is generally significant despite the absence of proprietary technology with respect to the size.

### BRIEF DESCRIPTION OF THE DRAWINGS

The Detailed Description is set forth with reference to the accompanying figures. In the figures, the left-most digit(s) of a reference number identifies the figure in which the reference number first appears. The use of the same reference numbers in different figures indicates similar or identical items. Furthermore, the drawings may be considered as providing an approximate depiction of the relative sizes of the individual components within individual figures. However, the drawings are not to scale, and the relative sizes of the individual components, both within individual figures and between the different figures, may vary from what is depicted. In particular, some of the figures may depict components as a certain size or shape, while other figures may depict the same components on a larger scale or differently shaped for the sake of clarity.

FIG. 1 illustrates an air handling system with an air filter and air filter adapter, according to at least one example.

FIG. 2 is a top perspective view of a first embodiment of an air filter adapter frame;

FIG. 3 is a front view thereof;

FIG. 4 is a back view thereof;

FIG. 5 is a side view thereof, which view is the same for both the left-side and the right side;

FIG. 6 is a side view thereof, which view is the same for both the top view and the bottom view;

FIG. 7 is a bottom cross-sectional view thereof, which view is taken at line 7-7, shown in FIG. 2;

FIG. 8 is a top perspective view of a second embodiment of an air filter adapter frame;

FIG. 9 is a front view thereof;

FIG. 10 is a back view thereof;

FIG. 11 is a side view thereof, which view is the same for both the left-side and the right side;

FIG. 12 is a side view thereof, which view is the same for both the top view and the bottom view;

FIG. 13 is a bottom cross-sectional view thereof, which view is taken at line 13-13, shown in FIG. 8.

FIGS. 14A-14F illustrate cross-sections of a profile of the air filter adapter frame of FIG. 2, which view is taken at line 14-14, shown in FIG. 2.

FIG. 15 illustrates the air filter adapter frame with an air filter positioned therein, according to at least one example.

FIG. 16 illustrates an air filter adapter frame with an air filter secured in place using securements, according to at least one example.

FIG. 17 illustrates an air filter adapter frame with an air filter secured in place using a face frame, according to at least one example.

### DETAILED DESCRIPTION

This description is directed to an air filter adapter frame. The air filter adapter frame may be sized according to the particular purpose for the use of the air filter, i.e., a device, machine, system, etc. However, a user may use or have access to an air filter that is sized different from the particular size required by the particular purpose. In such a situation, it is difficult to properly use the air filter. Accordingly, the air filter adapter frame as disclosed herein facilitates the use of a differently sized air filter to be used in the place of a proprietary sized filter.

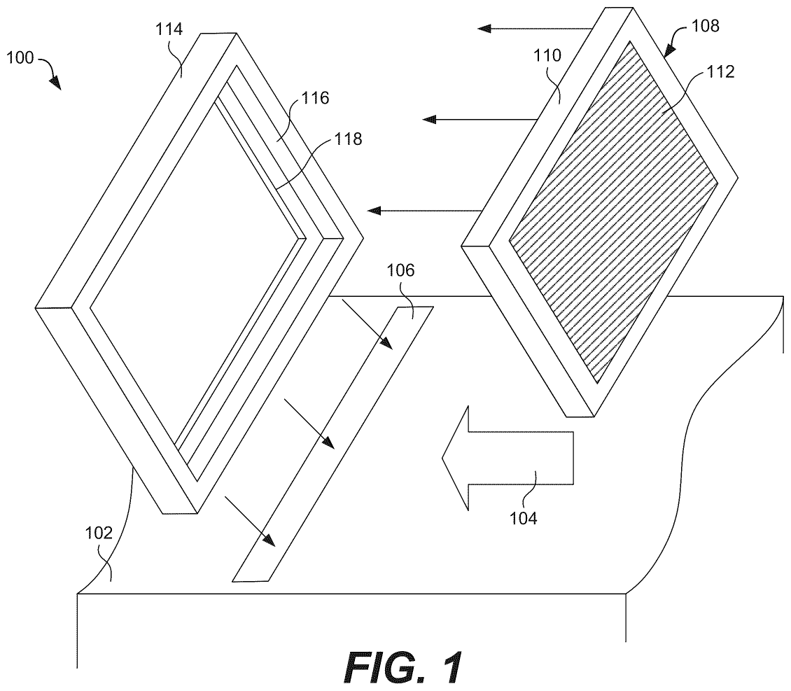

FIG. 1 illustrates an air handling system 100 with an air filter 108 and air filter adapter 114, according to at least one example. The air handling system 100 includes a duct 102 for handling moving air through the air handling system 100. In some examples, the air handling system 100 may include an air filtration system, a fan system, HVAC system, or other such system for handling air through a passage, duct, plenum, opening, or other conveyance system and through a filtration medium. The duct 102 carries air along a direction 104 along the inside of the duct 102 to a destination and is filtered while traveling through the duct 102. The duct 102 includes an opening 106 for inserting and removing a filter. The opening 106 may be up to or equal to the width of the duct 102. The opening 106 may have an access panel or hatch to close the opening 106 and prevent air from entering or exiting the duct 102 through the opening 106 during operation.

The duct 102 is sized to receive an air filter having a first size, with a first width and first length (and/or a first thickness). The air filter 108 shown in FIG. 1 may have one or more dimensions that differ from the first size, such as a second width, second length, and/or second thickness that are smaller than the first width, first length, and/or first thickness. Accordingly, the air filter 108 may not fit properly within the duct 102. The air filter 108 includes a frame 110 and filter media 112 positioned within the frame 110. The filter media may be any filter media suitable for filtering the material handled by the air handling system 100. In an embodiment, the dimensions of the air filter 108 may differ from dimensions of an air filter designed for the duct 102. Accordingly, the air filter 108 may not fit properly within the duct 102 and may allow air to bypass the air filter 108 and/or for the air filter 108 to move along the length of the duct 102 out of position and cause a blockage. In an embodiment, the air filter 108 may be a filter size or have dimensions that are more readily available and/or inexpensive than a filter having the dimensions required by the duct 102. Accordingly, a user may wish to fit the air filter 108 within the duct 102 for cost-saving and/or for other reasons such as availability of a particular type of filter (e.g., a HEPA filter or biological material filter that may not be available from a manufacturer in a required size for the duct).

Accordingly, the air filter 108 is fit within the air filter adapter 114 before being inserted through the opening 106 into the duct 102. The air filter adapter 114 interfaces with the frame 110 of the air filter 108 and extends one or more of the length, width, and/or thickness of the air filter 108 to fit within the opening 106 of the duct 102 and to fit within the duct 102 to provide proper filtration without bypassing the air filter 108 by flowing around.

The air filter adapter 114 includes a frame portion 116 and a flange portion 118 that extends from an inner lower edge of the frame portion 116. The frame portion 116 may vary in size such that the outermost perimeter is adapted to fit in a proprietarily sized opening of a filter location on the duct 102 such as in a machine, device, or system which provide air filtration. The air filter 108, having a different size than the duct 102 is designed to accept, is then accommodated within the frame portion 116 and set on the flange portion 118 for use. Though depicted as extending continuously around the entire inner perimeter, it is contemplated and considered to be part of the disclosed subject matter herein that the flange portion 118 may be discontinuous and in an embodiment, extends outward from segments of the inner perimeter of the frame at predetermined locations. The flange portion 118 facilitates setting a differently sized air filter (than the one required by a particular machine) to be place in the adapter frame and then be placed with the system, machine, or device. Thus, so long as the flange portion 118 supports the air filter placed thereon, the flange portion 118 may vary in size or shape as desired (i.e., multiple tabs, narrower extension, thinner/thicker flange, hooked edge, downturned edge, etc.

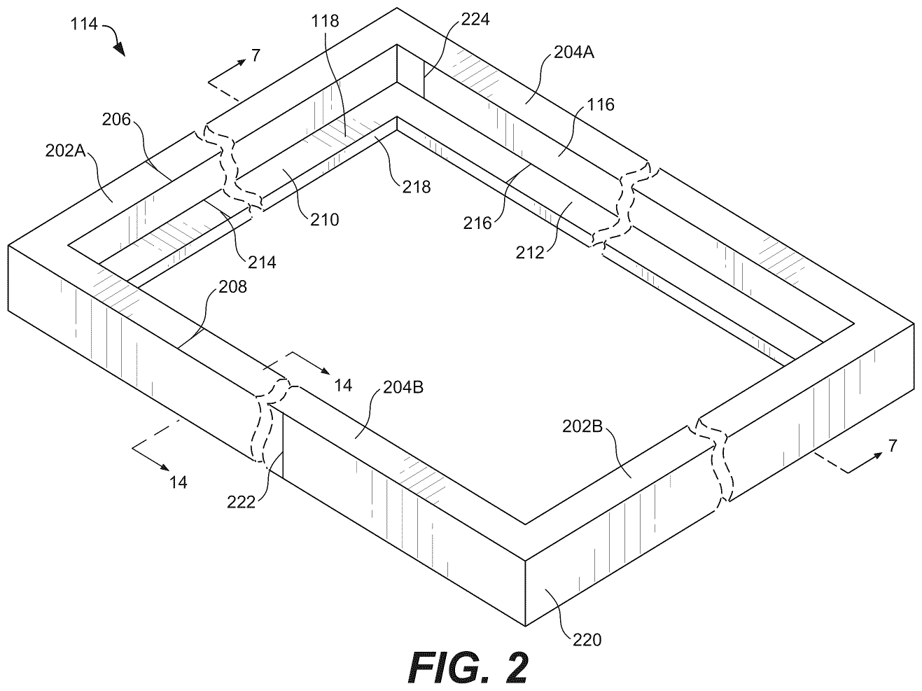

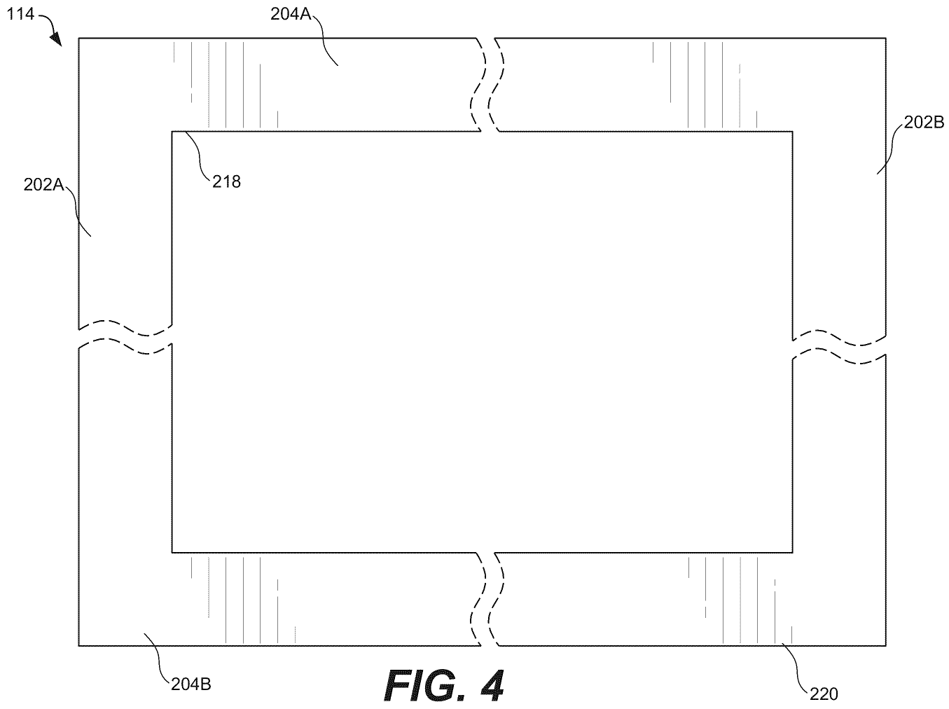

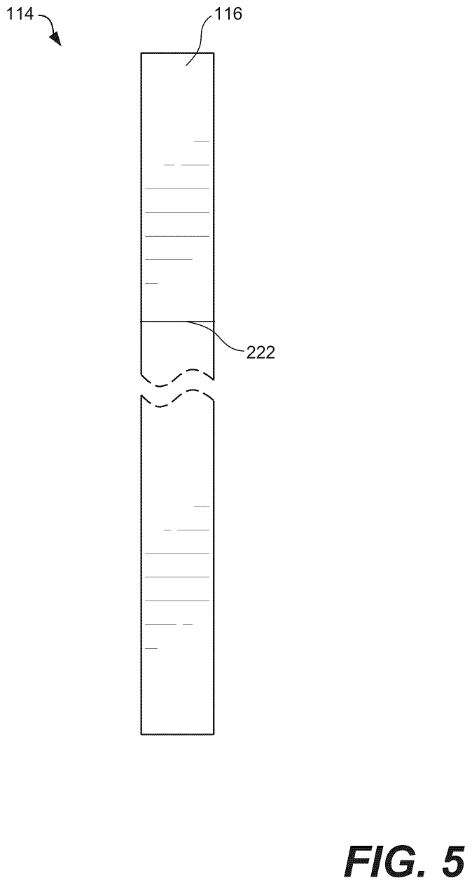

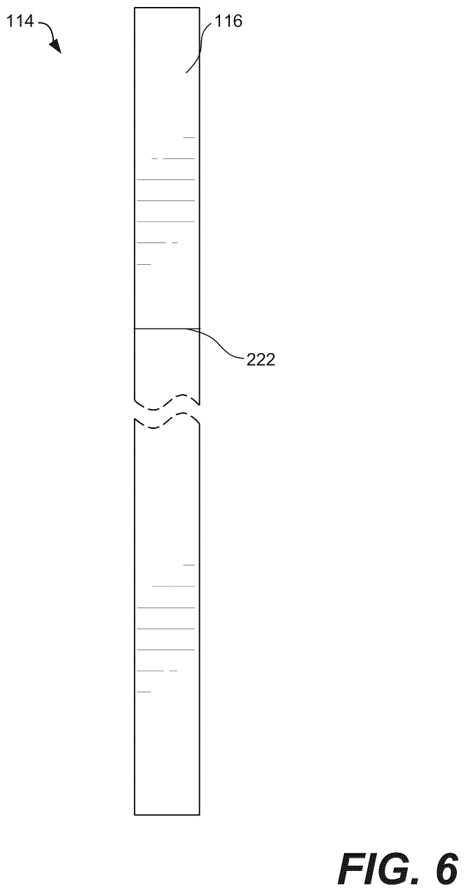

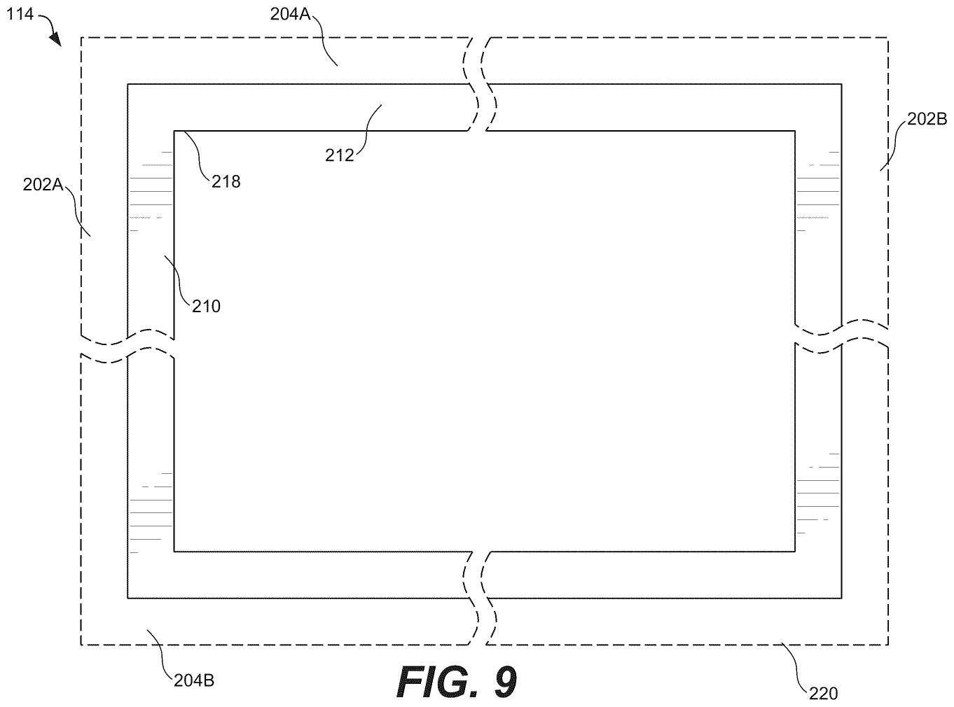

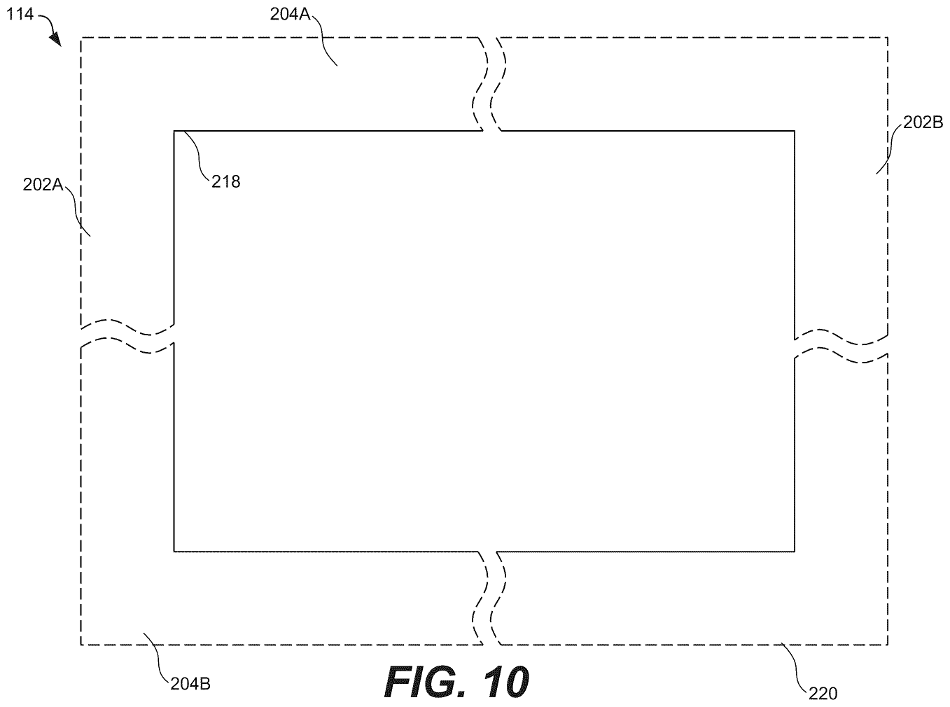

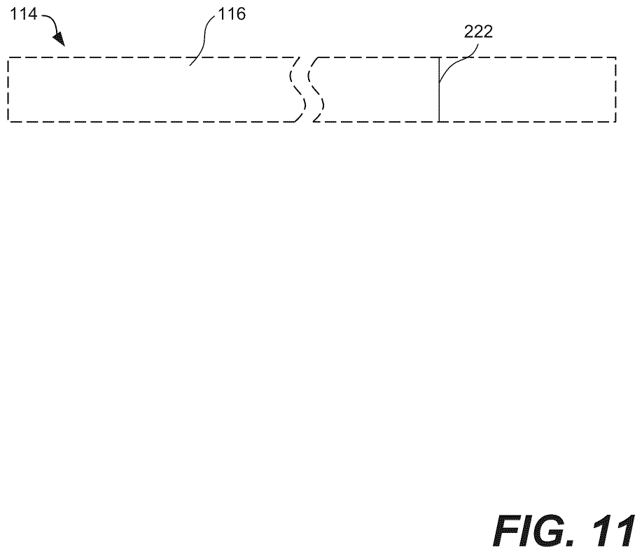

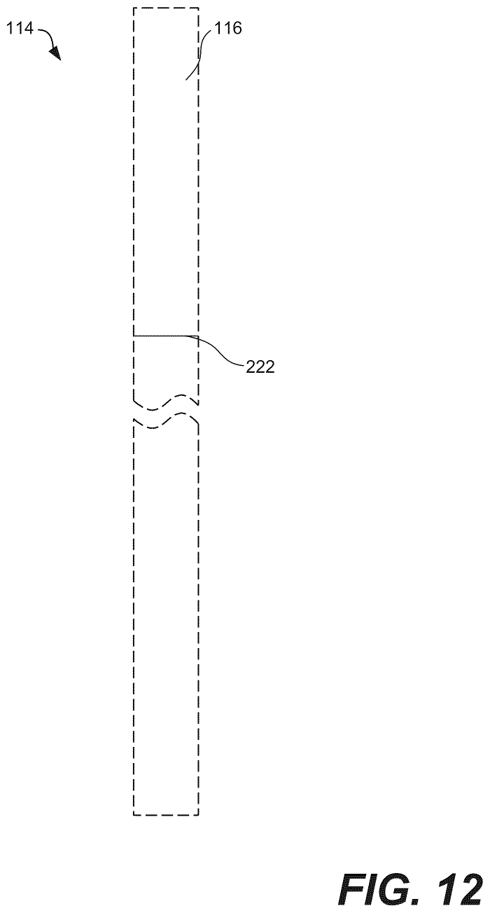

The air filter adapter 114 is shown and described in further detail with respect to FIGS. 2-17. The air filter adapter 114 may be formed of various materials including plastic, rubber, metal, wood, cardboard, composite, or other solid and/or rigid materials capable of supporting the air filter 108 against the air flow along direction 104. semi-solid materials

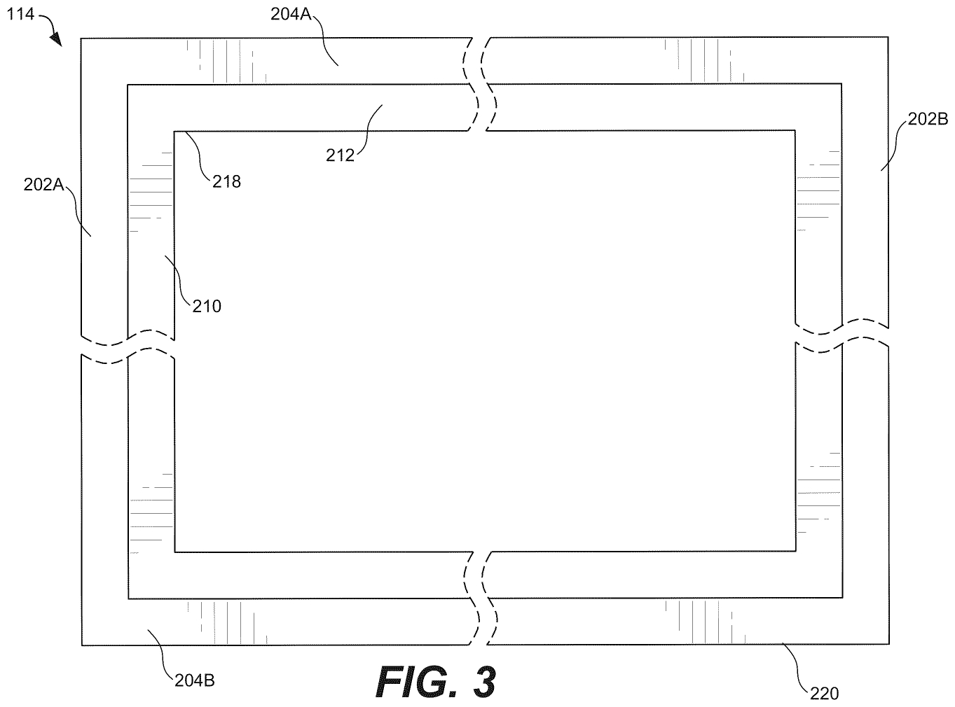

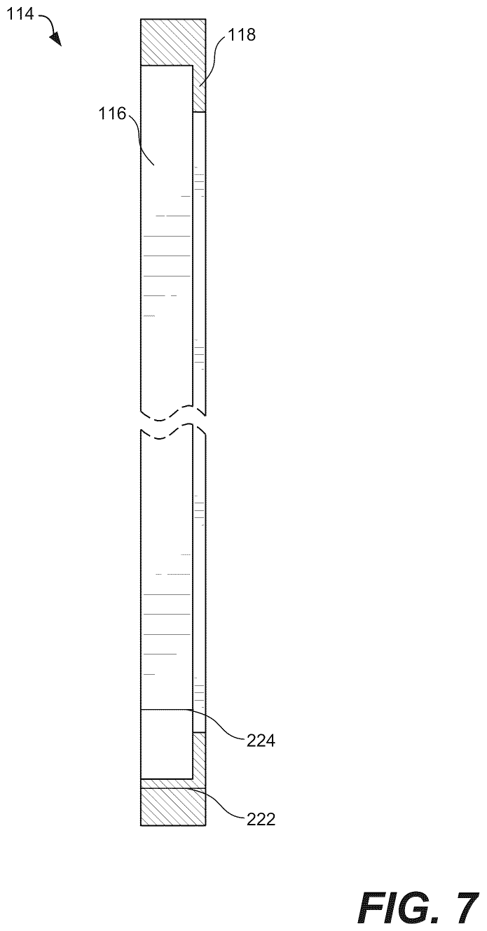

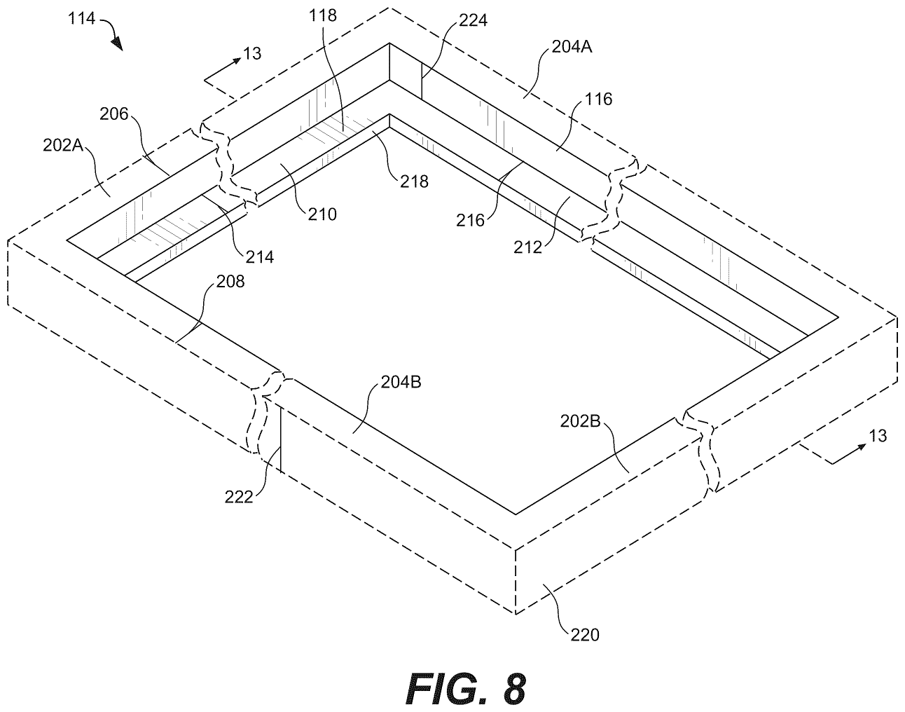

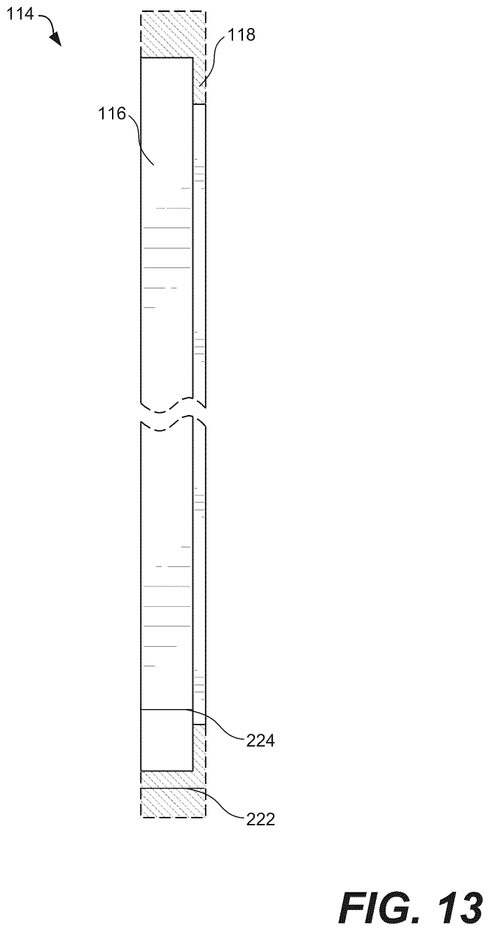

As indicated above, FIGS. 3-13 depict air filter adapter frames according to embodiments described herein. FIGS. 3-7 depict various other views as indicated above of the air filter adapter 114. Notably, FIG. 7 depicts a cross sectional view of the air filter adapter 114, taken at line 7-7 of FIG. 2, to show an embodiment of the flange portion 118. FIGS. 8-13 depict various other views as indicated above of the air filter adapter 114. Notably, FIG. 13 depicts a cross sectional view of the air filter adapter 114, taken at line 13-13 of FIG. 8, to show an embodiment of the flange portion 118.

Turning now to FIG. 2, that illustrates a top perspective view of a first embodiment of an air filter adapter 114, the air filter adapter 114 is shown without an air filter installed. The air filter adapter 114 is further illustrated with respect to FIGS. 3-13 at different perspectives and views. The air filter adapter 114 has a rectangular shape, with the sides of the air filter adapter 114 shown with section breaks. The air filter adapter 114 may have any suitable dimensions for fitting within a duct 102 of a specific machine, system, or implementation for the air filter.

The air filter adapter 114 is configured to interface with an air filter as depicted in FIG. 1 to increase the width, length, and/or thickness at the perimeter of the air filter and thereby ensure that the air filter fits securely within an opening or duct and doesn't leave a gap or opening around the perimeter of the air filter.

Though the air filter adapter 114 is shown having a rectangular shape, other shapes are contemplated such as square, triangular, trapezoidal, hexagonal, or other such shapes both geometric and non-geometric. The air filter adapter 114 may therefore provide for an air filter that has a different shape than a shape required to fit within the duct 102 to be used in a particular implementation. For example, a duct 102 may have a circular profile (e.g., cross-section), but a filter for use that is readily available may have a square or rectangular shape. A circular filter may be unavailable for one or more reasons. Accordingly, the air filter adapter may accommodate a different internal filter shape than the external shape of the air filter adapter 114 and thereby provide for the use of different shape or style air filters in the system.

The air filter adapter 114 includes a body formed of one or more materials such as a plastic, rubber, metal, cardboard, composite, combination thereof, or other such materials. The air filter adapter 114 includes a first side 202A and a first side 202B (collectively the first side 202) that define a width of the air filter adapter 114. The air filter adapter 114 also includes a second side 204A and a second side 204B (collectively the second side 204) that define a length of the air filter adapter 114. The first side 202 and the second side 204 may have equal or different lengths, and may vary in length to accommodate a variety of air filter sizes.

In an embodiment, the first side 202 and/or the second side 204 may be adjustable to accommodate a variety of air filter sizes and configurations. For instance, the air filter adapter 114 may include a telescoping portion of the first side 202 and/or the second side 204 to enable a user to adjust a size of the air filter adapter 114 to a custom implementation. The first side 202 and the second side 204 may be adjustable in length to change the length and width of the air filter adapter to fit within the duct 102.

The frame portion 116 that includes the first side 202 and the second side 204 has a first width 206 and a second width 208 corresponding with the first side 202 and the second side 204. The first width 206 may be in a range of one eighth of an inch to several inches in width. The first width 206 may be selected based on a difference between the dimensions at the duct 102 and the dimensions of the air filter 108. The second width 208 may be in a range of one eighth of an inch to several inches in width. The second width 208 may be selected based on a difference between the dimensions at the duct 102 and the dimensions of the air filter 108. In an embodiment, the first side 202 and the second side 204 may include a structural component and a compressible component. The compressible component may include a foam positioned on an interior surface of the first side 202 and the second side 204. The compressible component may enable the air filter 108 to have a variable length and/or width and still be contained within the air filter adapter 114. In an illustrative embodiment, the compressible component may include a foam and/or a spring that is capable of deflection in a range of up to or in excess of one inch such that the length and/or width of the air filter 108 may vary (e.g., by selecting different air filters) over a range of several inches without requiring a different air filter adapter. In an embodiment, the first side 202 and/or the second side 204 may be telescoping and/or adjustable in addition to the inclusion of a compressible component to enable adjustability and flexibility in receiving air filters of various sizes.

The flange portion 118 includes a first flange 210 and a second flange 212 that extend perpendicular or substantially perpendicular from the frame portion 116. The first flange 210 and the second flange 212 may connect at the corners of the air filter adapter 114 and/or may be continuous across the length and width of the air filter adapter 114 and/or may only span a portion of the length and width. In an embodiment, the first flange 210 and the second flange may only extend from a portion of the first side 202 and the second side 204 but may not be continuous. The first flange 210 has a first width 214 that defines a distance the first flange extends perpendicularly from the first side 202. The first width 214 may be in a range of one eighth of an inch to over an inch. In an embodiment, the first width 214 may correspond to a width of the frame 110 of the air filter 108. The first flange 210 has a first width 214 to support the air filter 108 and prevent the air filter 108 from passing through an opening in a center of the air filter adapter 114. The second flange 212 has a second width 216 that defines a distance the first flange extends perpendicularly from the second side 204. The second width 216 may be in a range of one eighth of an inch to over an inch. In an embodiment, the second width 216 may correspond to a width of the frame 110 of the air filter 108. The second flange 212 has a second width 216 to support the air filter 108 and prevent the air filter 108 from passing through an opening in a center of the air filter adapter 114. The first width 214 may be the same or different from the second width in an embodiment.

In an embodiment, the air filter adapter 114 may include only one of the first flange 210 or the second flange 212 on opposite sides (e.g., the first flange 210 on each of the first side 202 but without a second flange 212). The first flange 210 and the second flange 212 are each formed of a rigid material that supports the air filter 108 and resists the air filter 108 being pushed by airflow through the air filter adapter 114. The first flange 210 and the second flange 212 have a thickness in a range of less than one eighth of an inch to over a quarter of an inch.

The flange portion 118 defines an inner perimeter 218 through which air passes after passing through the air filter 108. The perimeter of the inner perimeter 218 is defined by the first flange 210 and the second flange 212. The open area of the interior opening (e.g., the width and length of the inner perimeter 218) may correspond, in an embodiment, to a width and length of the filter media 112 of the air filter 108. In this manner, the air may pass through the entire surface of the air filter 108 without constricting the air flow to a surface area smaller than the area of the filter media 112.

The inner perimeter 218 may have a variety of widths and lengths defining an interior opening, for example in a range of six inches to more than thirty inches in a first dimension and in a range of six inches to more than thirty inches in a second dimension. The inner perimeter 218 may correspond to the size and/or shape of the duct 102 and/or other system where the air filter 108 is to be installed.

The perimeter 220 of the air filter adapter 114 is defined by the frame portion 116 and in particular by an outer surface of the first side 202 and an outer surface of the second side 204. The perimeter 220 may correspond to the dimensions of an opening and/or filter holding portion of a system or machine. In an embodiment, the perimeter 220 may be adjustable to accommodate a variety of air filter sizes and configurations. For instance, the air filter adapter 114 may include a telescoping portion of the first side 202 and/or the second side 204 to enable a user to adjust a size of the air filter adapter 114 to a custom implementation. The first side 202 and the second side 204 may be adjustable in length to change the length and width of the air filter adapter to fit within the duct 102.

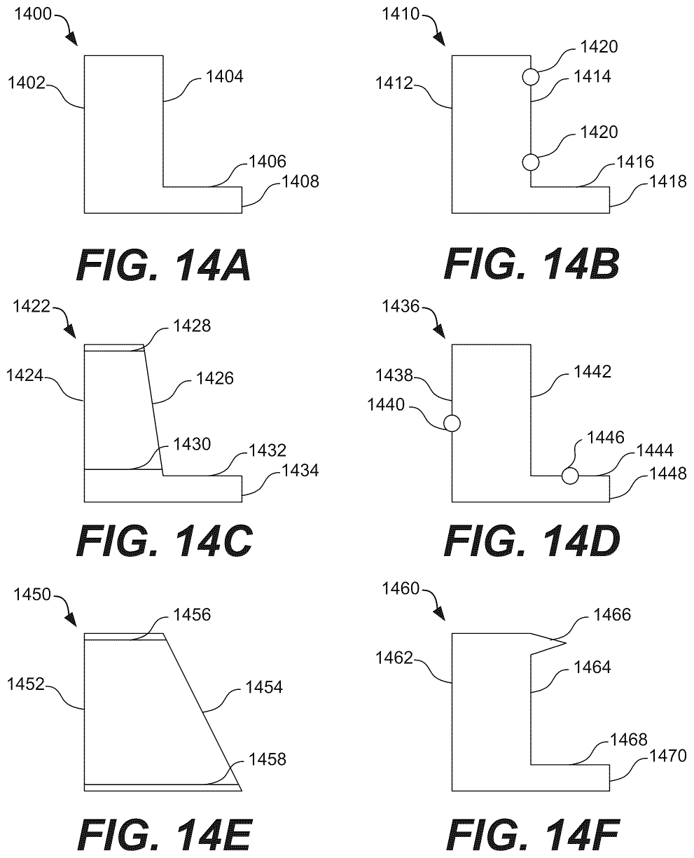

The frame portion 116 has a thickness 222 at the perimeter 220 of the air filter adapter 114 and the frame portion 116 has a thickness 224 at an inner perimeter of the frame portion 116 (e.g., an inner surface of the first side 202 and the second side 204). The thickness of the flange portion 118 corresponds to a difference, in at least one embodiment, between the thickness 222 and the thickness 224. The thickness 224 at the inner perimeter of the frame portion 116 may, in an example correspond to a thickness of the air filter 108. In an embodiment, the thickness 224 may be less than a thickness of the air filter 108. In an embodiment, the thickness 224 may be greater than a thickness of the air filter 108. Additional details regarding the shape and configuration of the first side 202, second side 204, and/or flange portion 118 are shown and described with respect to FIGS. 14A-14F.

The section view depicted in FIGS. 7 and 13 illustrate a profile of the air filter adapter 114 taken along the lines 7-7 in FIGS. 2 and 13-13 in FIG. 8. The section views depict the dimensions and relationships of the frame portion 116, flange portion 118, and other components of the air filter adapter. Though depicted in FIGS. 7 and 13 as being formed of a solid material, in some embodiments, the air filter adapter 114 may be hollow and/or include one or more passages through the frame portion 116.

FIGS. 14A-14F illustrate cross-sections of a profile of the air filter adapter of FIG. 2, which view is taken at line 14-14, shown in FIG. 2. The cross-sections are depicted at the line 14-14, positioned on the second side 204B though the cross-sections may also correspond to the cross-section of the first side 202. Though various embodiments are shown, the embodiments are intended to be illustrative examples of combinations of various features and profiles. In some embodiments, the cross-sections of the air filter adapter 114 may include features from one or more of the cross-sections depicted in FIGS. 14A-14F.

FIG. 14A illustrates a cross-section 1400 for the air filter adapter 114 of FIG. 2. The cross-section 1400 depicts an embodiment of a profile for the air filter adapter 114 taken at line 14-14 of FIG. 2. As depicted, the cross-section 1400 includes an outer surface 1402, a first inner surface 1404, a flange 1406, and a second inner surface 1408. The outer surface 1402 may correspond to the perimeter 220 and the first inner surface 1404 may correspond to an inner surface of the first side 202 and/or the second side 204. The flange 1406 corresponds to the flange portion 118 as described herein and second inner surface 1408 may correspond to inner perimeter 218.

The cross-section 1400 shows a rectangular frame portion defined by the outer surface 1402 and the first inner surface 1404. The cross-section 1400 also shows a flange 1406 extending perpendicularly from a bottom edge of the first inner surface 1404. In an embodiment, the flange 1406 may extend at an angle other than perpendicular from the first inner surface 1404. In an embodiment, the flange 1406 extends from a middle portion of the first inner surface 1404 rather than an end (e.g., bottom) of the first inner surface 1404. Though depicted as rectangular shapes, the profile of the cross-section 1400 may have other shapes, including rounded shapes and corners, and other such profiles.

The thickness between the outer surface 1402 and the first inner surface 1404 may be in a range of one eighth of an inch to several inches in width. The thickness may be selected based on a difference between the dimensions at the duct 102 and the dimensions of the air filter 108. In some examples, the thickness may vary between the first side 202 and the second side 204.

The flange 1406 has a thickness that enables the flange 1406 to support the air filter 108 when positioned within the duct 102. The flange 1406 may include the first flange 210 and the second flange 212 as shown in FIG. 2. The flange 1406 has a width that defines a distance the flange 1406 extends perpendicularly from the first inner surface 1404. The width may be in a range of one eighth of an inch to over an inch. In an embodiment, the width may correspond to a width of the frame 110 of the air filter 108. The flange 1406 has a width to support the air filter 108 and prevent the air filter 108 from passing through the opening defined at least in part by the second inner surface 1408. The width may vary between the first side 202 and the second side 204 of the air filter adapter 114.

The flange 1406 is formed of a rigid material that supports the air filter 108 and resists the air filter 108 being pushed by airflow through the air filter adapter 114. The flange 1406 may have a thickness in a range of less than one eighth of an inch to over a quarter of an inch.

The flange 1406 includes the second inner surface 1408 that defines, at least in part, an interior opening through which air passes after passing through the air filter 108. The perimeter of the interior opening is defined at least in part by the flange 1406.

FIG. 14B illustrates a cross-section 1410 for the air filter adapter 114 of FIG. 2. The cross-section 1410 depicts an embodiment of a profile for the air filter adapter 114 taken at line 14-14 of FIG. 2. As depicted, the cross-section 1410 includes an outer surface 1412, a first inner surface 1414, a flange 1416, a second inner surface 1418, and a compressible component 1420. The outer surface 1412 may correspond to the perimeter 220 and the first inner surface 1414 may correspond to an inner surface of the first side 202 and/or the second side 204. The flange 1416 corresponds to the flange portion 118 as described herein and second inner surface 1418 may correspond to inner perimeter 218.

The cross-section 1410 shows a rectangular frame portion defined by the outer surface 1412 and the first inner surface 1414. The cross-section 1410 also shows a flange 1416 extending perpendicularly from a bottom edge of the first inner surface 1414. In an embodiment, the flange 1416 may extend at an angle other than perpendicular from the first inner surface 1414. In an embodiment, the flange 1416 extends from a middle portion of the first inner surface 1414 rather than an end (e.g., bottom) of the first inner surface 1414.

The thickness between the outer surface 1412 and the first inner surface 1414 may be in a range of one eighth of an inch to several inches in width. The thickness may be selected based on a difference between the dimensions at the duct 102 and the dimensions of the air filter 108. In some examples, the thickness may vary between the first side 202 and the second side 204.

The flange 1416 has a thickness that enables the flange 1416 to support the air filter 108 when positioned within the duct 102. The flange 1416 may include the first flange 210 and the second flange 212 as shown in FIG. 2. The flange 1416 has a width that defines a distance the flange 1416 extends perpendicularly from the first inner surface 1414. The width may be in a range of one eighth of an inch to over an inch. In an embodiment, the width may correspond to a width of the frame 110 of the air filter 108. The flange 1416 has a width to support the air filter 108 and prevent the air filter 108 from passing through the opening defined at least in part by the second inner surface 1418. The width may vary between the first side 202 and the second side 204 of the air filter adapter 114.

The flange 1416 is formed of a rigid material that supports the air filter 108 and resists the air filter 108 being pushed by airflow through the air filter adapter 114. The flange 1416 may have a thickness in a range of less than one eighth of an inch to over a quarter of an inch.

The flange 1416 includes the second inner surface 1418 that defines, at least in part, an interior opening through which air passes after passing through the air filter 108. The perimeter of the interior opening is defined at least in part by the flange 1416.

The cross-section 1410 also shows a compressible component 1420 positioned on the first inner surface 1414. The compressible component 1420 may include a rubber gasket or O-ring that extends around the inner perimeter of the frame portion 116 and interfaces with an outer perimeter of the frame 110 of the air filter 108. The compressible component 1420 may compress when the air filter 108 is placed within the air filter adapter 114 and may resiliently deform to provide a force against the frame 110 to seal a gap around the perimeter of the air filter 108 between the air filter 108 and the first inner surface 1414. Though depicted with two compressible components 1420, the air filter adapter 114 may include one, two, three, or more compressible components 1420 positioned on the first inner surface 1414.

The compressible component 1420 may include a foam positioned on the first inner surface 1414. In addition to providing a seal between the air filter 108 and the air filter adapter 114, the compressible component may enable the air filter 108 to have a variable length and/or width and still be contained within the air filter adapter 114. In an illustrative embodiment, the compressible component may include a foam and/or a spring that is capable of deflection in a range of up to or in excess of one inch such that the length and/or width of the air filter 108 may vary (e.g., by selecting different air filters) over a range of several inches without requiring a different air filter adapter.

FIG. 14C illustrates a cross-section 1422 for the air filter adapter 114 of FIG. 2. The cross-section 1422 depicts an embodiment of a profile for the air filter adapter 114 taken at line 14-14 of FIG. 2. As depicted, the cross-section 1422 includes an outer surface 1424, a first inner surface 1426, a flange 1432, and a second inner surface 1434. The outer surface 1424 may correspond to the perimeter 220 and the first inner surface 1426 may correspond to an inner surface of the first side 202 and/or the second side 204. The flange 1432 corresponds to the flange portion 118 as described herein and second inner surface 1434 may correspond to inner perimeter 218.

The cross-section 1422 shows the frame portion with the first inner surface 1426 tapered with respect to the outer surface 1424. The cross-section 1422 also shows a flange 1432 extending perpendicularly from a bottom edge of the first inner surface 1426. In an embodiment, the flange 1432 may extend at an angle other than perpendicular from the first inner surface 1426. The flange 1432 may extend at an angle of less than or more than ninety degrees relative to the outer surface 1424. In an embodiment, the flange 1432 extends from a middle portion of the first inner surface 1426 rather than an end (e.g., bottom) of the first inner surface 1426.

The thickness between the outer surface 1424 and the first inner surface 1426 may vary due to the taper of the first inner surface 1426 relative to the outer surface 1424. The thickness may be in a range of one eighth of an inch to several inches in width. At a top end of the frame portion, the thickness 1428 may be less than a thickness 1430 at or adjacent a second end of the frame portion. The tapered shape of the frame portion may cause the air filter 108 to be pressed tighter into the air filter adapter 114 as air is forced through the air filter 108. The pressure against the air filter 108 may cause the air filter 108 to advance towards the flange 1432 and be compressed and held tightly within the air filter adapter. In addition to securely holding the air filter 108, this may aid in sealing the interface between the air filter 108 and the air filter adapter 114. The thickness 1428 and the thickness 1430 may be selected based on a difference between the dimensions at the duct 102 and the dimensions of the air filter 108. In addition, the taper may be only slight, and include a taper of up to five degrees. In some examples, the taper may be five to fifteen degrees or more. The increased taper may result in greater compression of the air filter 108 against the air filter adapter 114. In some examples, the thickness may vary between the first side 202 and the second side 204.

The flange 1432 has a thickness that enables the flange 1432 to support the air filter 108 when positioned within the duct 102. The flange 1432 may include the first flange 210 and the second flange 212 as shown in FIG. 2. The flange 1432 has a width that defines a distance the flange 1432 extends from the first inner surface 1426. The width may be in a range of one eighth of an inch to over an inch. The width may include a distance the flange 1432 extends in a direction perpendicular to the outer surface 1424. In an embodiment, the width may correspond to a width of the frame 110 of the air filter 108. The flange 1432 has a width to support the air filter 108 and prevent the air filter 108 from passing through the opening defined at least in part by the second inner surface 1434. The width may vary between the first side 202 and the second side 204 of the air filter adapter 114.

The flange 1432 is formed of a rigid material that supports the air filter 108 and resists the air filter 108 being pushed by airflow through the air filter adapter 114. The flange 1432 may have a thickness in a range of less than one eighth of an inch to over a quarter of an inch.

The flange 1432 includes the second inner surface 1434 that defines, at least in part, an interior opening through which air passes after passing through the air filter 108. The perimeter of the interior opening is defined at least in part by the flange 1432.

FIG. 14D illustrates a cross-section 1436 for the air filter adapter 114 of FIG. 2. The cross-section 1436 depicts an embodiment of a profile for the air filter adapter 114 taken at line 14-14 of FIG. 2. As depicted, the cross-section 1436 includes an outer surface 1438, a first compressible component 1440, a first inner surface 1442, a flange 1444, a second compressible component 1446, and a second inner surface 1448. The outer surface 1438 may correspond to the perimeter 220 and the first inner surface 1442 may correspond to an inner surface of the first side 202 and/or the second side 204. The flange 1444 corresponds to the flange portion 118 as described herein and second inner surface 1448 may correspond to inner perimeter 218.

The cross-section 1436 shows a rectangular frame portion defined by the outer surface 1438 and the first inner surface 1442. The cross-section 1436 also shows a flange 1444 extending perpendicularly from a bottom edge of the first inner surface 1442. In an embodiment, the flange 1444 may extend at an angle other than perpendicular from the first inner surface 1442. The flange 1444 may extend at an angle less than or greater than ninety degrees from the first inner surface 1442. In an embodiment, the flange 1444 extends from a middle portion of the first inner surface 1442 rather than an end (e.g., bottom) of the first inner surface 1442.

The thickness between the outer surface 1438 and the first inner surface 1442 may be in a range of one eighth of an inch to several inches in width. The thickness may be selected based on a difference between the dimensions at the duct 102 and the dimensions of the air filter 108. In some examples, the thickness may vary between the first side 202 and the second side 204.

The first compressible component 1440 is positioned on the outer surface 1438. The first compressible component 1440 may include a rubber gasket or O-ring that extends around the outer perimeter of the frame portion 116 and interfaces with an inner perimeter of the duct, passage, or other system where the air filter and air filter adapter are installed. The first compressible component 1440 may compress when the air filter adapter 114 is placed within the duct 102 and may resiliently deform to provide a force against the duct 102 to seal a gap around the perimeter of the air filter adapter 114 between the air filter adapter 114 and the duct 102. Though depicted with a first compressible component 1440, the air filter adapter 114 may include one, two, three, or more first compressible components 1440 positioned on the outer surface 1438.

The first compressible component 1440 may include a foam positioned on the outer surface 1438. In an illustrative embodiment, the first compressible component 1440 may include a foam, rubber, and/or a spring that is capable of deflection in a range of up to or in excess of one inch.

The flange 1444 has a thickness that enables the flange 1444 to support the air filter 108 when positioned within the duct 102. The flange 1444 may include the first flange 210 and the second flange 212 as shown in FIG. 2. The flange 1444 has a width that defines a distance the flange 1444 extends perpendicularly from the first inner surface 1442. The width may be in a range of one eighth of an inch to over an inch. In an embodiment, the width may correspond to a width of the frame 110 of the air filter 108. The flange 1444 has a width to support the air filter 108 and prevent the air filter 108 from passing through the opening defined at least in part by the second inner surface 1448. The width may vary between the first side 202 and the second side 204 of the air filter adapter 114.

The flange 1444 is formed of a rigid material that supports the air filter 108 and resists the air filter 108 being pushed by airflow through the air filter adapter 114. The flange 1444 may have a thickness in a range of less than one eighth of an inch to over a quarter of an inch.

The flange 1444 includes the second compressible component 1446 positioned on an interface of the flange 1444 facing the air filter 108 when the air filter is installed in the air filter adapter 114. The second compressible component 1446 may include a rubber gasket or O-ring that extends around the outer perimeter of the flange portion 118 and interfaces with the air filter 108 such as at the frame 110 of the air filter 108. The second compressible component 1446 may compress when the air filter 108 is positioned within the air filter adapter 114 and may resiliently deform to provide a force against the air filter 108 to seal a gap around the perimeter of the air filter 108 between the air filter 108 and the air filter adapter 114. Though depicted with a second compressible component 1446, the air filter adapter 114 may include one, two, three, or more second compressible components 1446 positioned on the flange 1444.

The second compressible component 1446 may include a foam positioned on the flange 1444. In an illustrative embodiment, the compressible component may include a foam, rubber, and/or a spring that is capable of deflection in a range of up to or in excess of one inch.

The flange 1444 includes the second inner surface 1448 that defines, at least in part, an interior opening through which air passes after passing through the air filter 108. The perimeter of the interior opening is defined at least in part by the flange 1444.

FIG. 14E illustrates a cross-section 1450 for the air filter adapter 114 of FIG. 2. The cross-section 1450 depicts an embodiment of a profile for the air filter adapter 114 taken at line 14-14 of FIG. 2. As depicted, the cross-section 1450 includes an outer surface 1452 and an inner surface 1454. The outer surface 1424 may correspond to the perimeter 220 and the inner surface 1454 may correspond to an inner surface of the first side 202 and/or the second side 204 as well as the inner perimeter 218.

The cross-section 1450 shows the frame portion with the inner surface 1454 tapered with respect to the outer surface 1452. The thickness between the outer surface 1452 and the inner surface 1454 may vary due to the taper of the inner surface 1454 relative to the outer surface 1452. The thickness may be in a range of one eighth of an inch to several inches in width. At a top end of the frame portion 116, the thickness 1456 may be less than a thickness 1458 at or adjacent a second end of the frame portion 116. The tapered shape of the frame portion may cause the air filter 108 to be pressed tighter into the air filter adapter 114 as air is forced through the air filter 108. The pressure against the air filter 108 may cause the air filter 108 to advance towards the wider end of the cross-section 1450 and therefore be compressed and held tightly within the air filter adapter 114. In addition to securely holding the air filter 108, this may aid in sealing the interface between the air filter 108 and the air filter adapter 114. The thickness 1456 and the thickness 1458 may be selected based on a difference between the dimensions at the duct 102 and the dimensions of the air filter 108. In addition, the taper may be only slight, and include a taper of up to five degrees. In some examples, the taper may be five to fifteen degrees or more. The increased taper may result in greater compression of the air filter 108 against the air filter adapter 114. In some examples, the thickness may vary between the first side 202 and the second side 204. The taper of the cross-section 1450 may also enable the air filter adapter 114 to interface with several different sizes of air filters. For example, a first air filter having a first width may rest at a different height along the height of the inner surface 1454 than a second air filter having a second width. In an embodiment, when the first width is greater than the second width, the second air filter will rest closer to the bottom edge of the cross-section 1450.

FIG. 14F illustrates a cross-section 1460 for the air filter adapter 114 of FIG. 2. The cross-section 1460 depicts an embodiment of a profile for the air filter adapter 114 taken at line 14-14 of FIG. 2. As depicted, the cross-section 1460 includes an outer surface 1462, a first inner surface 1464, a protrusion 1466, a flange 1468, and a second inner surface 1470. The outer surface 1462 may correspond to the perimeter 220 and the first inner surface 1464 may correspond to an inner surface of the first side 202 and/or the second side 204. The flange 1468 corresponds to the flange portion 118 as described herein and second inner surface 1470 may correspond to inner perimeter 218.

The cross-section 1460 shows a rectangular frame portion defined by the outer surface 1462 and the first inner surface 1464. The cross-section 1460 depicts a protrusion 1466 extending from a top edge of the first inner surface 1464. The protrusion 1466 is depicted as having a width less than a width of the flange 1468 and also has a thickness that is less than a thickness of the flange 1468. The protrusion 1466 is depicted as tapering from a thickest portion adjacent the first inner surface 1464 to a thinnest portion at a distal end of the protrusion 1466. The protrusion 1466 may have other shapes and profiles in other embodiments. The protrusion 1466 may allow the air filter 108 to be inserted into the air filter adapter 114 and may resist removal of the air filter 108 from the air filter adapter 114 after insertion. The protrusion 1466 extends to a first width less than a width of the flange 1468 such that the air filter 108 may pass the protrusion 1466 without significant deformation or damage to the air filter 108. In this manner, the air filter 108 may be retained in place and resist removal or falling out of the air filter adapter 114 when installed. The protrusion 1466 may be formed of a pliant material such as a rubber and/or may be formed of the same material as the remainder of the air filter adapter 114.

The cross-section 1460 also shows a flange 1468 extending perpendicularly from a bottom edge of the first inner surface 1464. In an embodiment, the flange 1468 may extend at an angle other than perpendicular from the first inner surface 1464. In an embodiment, the flange 1468 extends from a middle portion of the first inner surface 1464 rather than an end (e.g., bottom) of the first inner surface 1464. Though depicted as rectangular shapes, the profile of the cross-section 1460 may have other shapes, including rounded shapes and corners, and other such profiles.

The thickness between the outer surface 1462 and the first inner surface 1464 may be in a range of one eighth of an inch to several inches in width. The thickness may be selected based on a difference between the dimensions at the duct 102 and the dimensions of the air filter 108. In some examples, the thickness may vary between the first side 202 and the second side 204.

The flange 1468 has a thickness that enables the flange 1468 to support the air filter 108 when positioned within the duct 102. The flange 1468 may include the first flange 210 and the second flange 212 as shown in FIG. 2. The flange 1468 has a width that defines a distance the flange 1468 extends perpendicularly from the first inner surface 1464. The width may be in a range of one eighth of an inch to over an inch. In an embodiment, the width may correspond to a width of the frame 110 of the air filter 108. The flange 1468 has a width to support the air filter 108 and prevent the air filter 108 from passing through the opening defined at least in part by the second inner surface 1470. The width may vary between the first side 202 and the second side 204 of the air filter adapter 114.

The flange 1468 is formed of a rigid material that supports the air filter 108 and resists the air filter 108 being pushed by airflow through the air filter adapter 114. The flange 1468 may have a thickness in a range of less than one eighth of an inch to over a quarter of an inch.

The flange 1468 includes the second inner surface 1470 that defines, at least in part, an interior opening through which air passes after passing through the air filter 108. The perimeter of the interior opening is defined at least in part by the flange 1468.

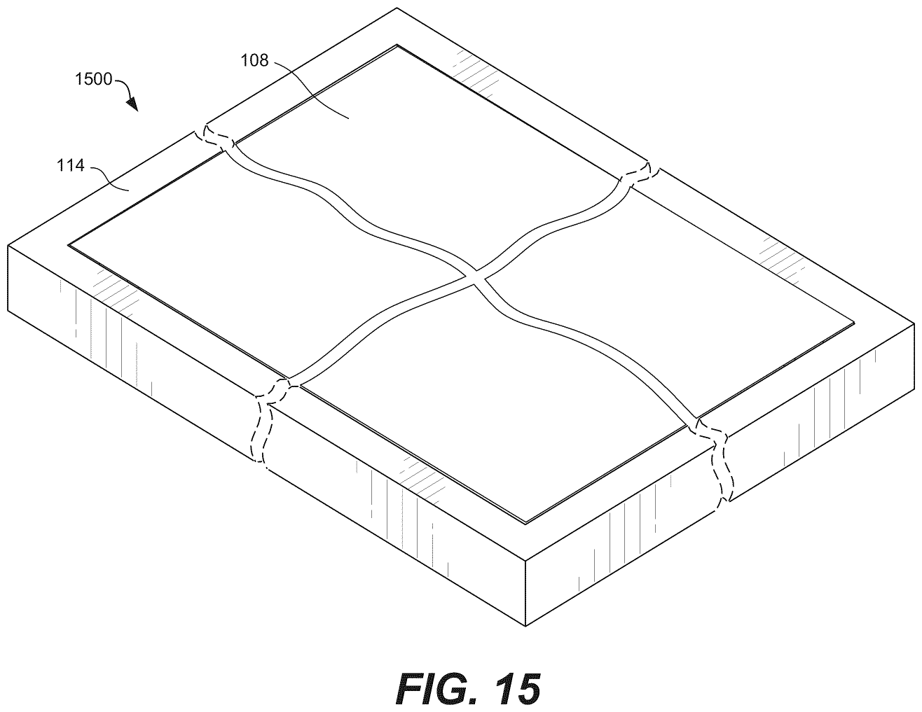

FIG. 15 illustrates an example of a filter component 1500 including the air filter adapter 114 with an air filter 108 positioned therein, according to at least one example. The filter component 1500 may be an example of a filter component that may be installed into a system or machine that includes an air handling machine and incorporates a filter. The filter component 1500 is depicted with the air filter 108 positioned within the frame portion 116 as described herein and held in place at least in part by the flange portion 118 that prevents the air filter 108 from passing through the air filter adapter 114. The air filter 108 and air filter adapter 114 may be inserted into an opening in a duct or to a portion of a system or machine to provide air filtration through the air filter 108.

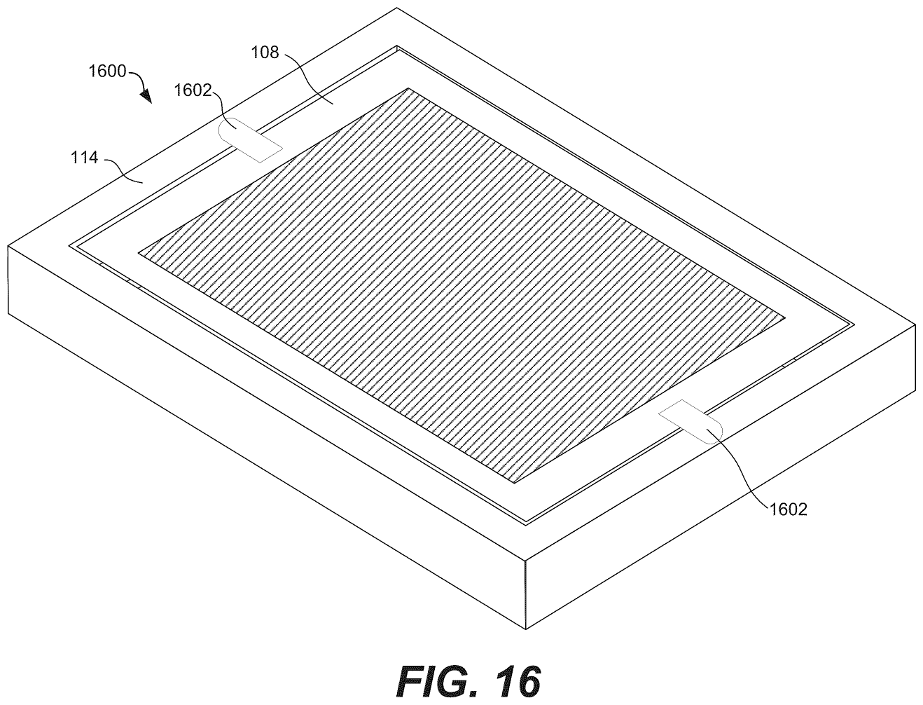

FIG. 16 illustrates an embodiment 1600 of an air filter adapter 114 with an air filter 108 secured in place using securements, according to at least one example. In the embodiment 1600, the air filter 108 is inserted into the air filter adapter 114, as shown and described herein. In the embodiment 1600, the air filter 108 is secured in place with tabs 1602. The tabs 1602 swivel or pivot to allow or prevent removal of the air filter 108 from the air filter adapter 114. Though depicted with two tabs 1602, in some examples there may be one, two, three, four, or more tabs 1602 around the perimeter of the air filter 108. The tabs 1602 are depicted on opposite sides of the air filter 108 but may be positioned around the air filter adapter 114 in any suitable position or location to secure the air filter 108 into the air filter adapter.

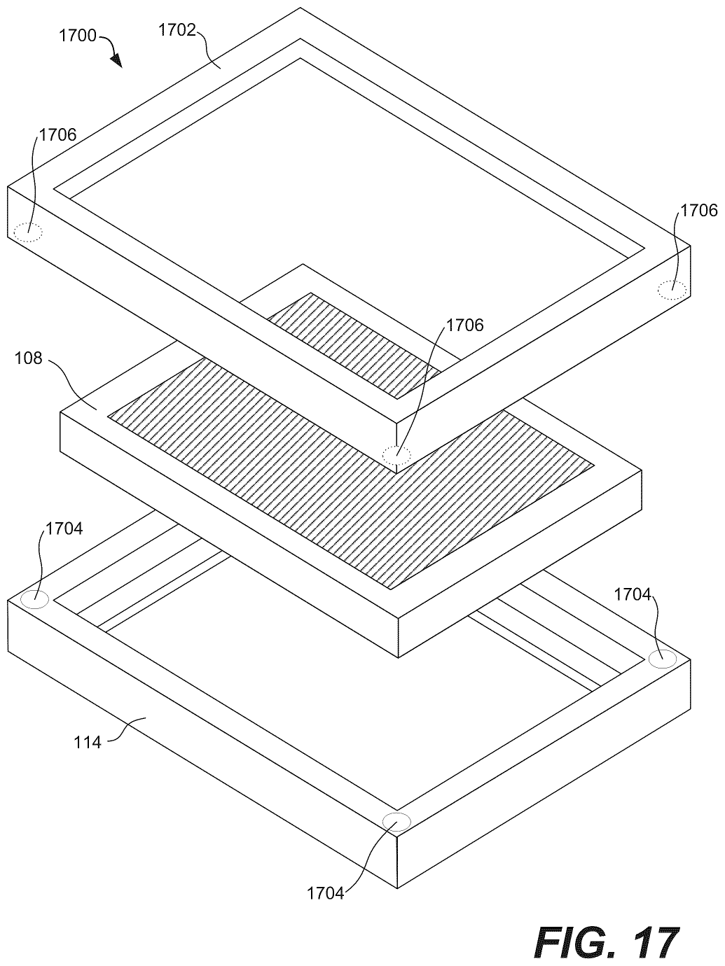

FIG. 17 illustrates a system 1700 for an air filter adapter 114 with an air filter 108 secured in place using a face frame 1702, according to at least one example. In the system 1700, the air filter 108 is inserted into the air filter adapter 114, as shown and described herein. The air filter 108 is held in place with a face frame 1702 that releasably secures to the air fitter adapter to at least partially enclose a frame 110 of the air filter 108 between the air filter adapter 114 and the face frame 1702. The face frame 1702 at least partially covers a perimeter of the air filter 108 to resists removal of the air filter 108 from the air filter adapter 114 until the face frame 1702 is removed.

The face frame 1702 is releasably secured to the air filter adapter 114 through the use of magnets. First magnets 1704 positioned within or at the surface of the air filter adapter 114 engage with second magnets 1706 positioned within or at the surface of the face frame 1702. The first magnets 1704 may be oriented to attract the second magnets 1706 to provide a force to hold the face frame 1702 against the air filter adapter 114. Though depicted with magnets, the face frame 1702 may be secured withe other types of releasable closures such as threaded connectors, buttons, hook and loop fasteners, and other such releasable fastening components.

While the invention is described with respect to the specific embodiments, it is to be understood that the scope of the invention is not limited to these specific embodiments. Since other modifications and changes varied to fit particular operating requirements and environments will be apparent to those skilled in the art, the invention is not considered limited to the embodiments chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. An air filter adapter comprising:
a frame portion including:
a first side opposite a second side, wherein the first side and the second side each have a first length and a first width;
a third side opposite a fourth side, wherein the third side and the fourth side each have a second length and a second width, wherein the frame portion is configured to surround a perimeter of an air filter; and
a flange portion that extends at least partially from an inner perimeter of the frame portion, the flange portion having a third width and defining an inner opening, and wherein the flange portion is adjacent a bottom edge of the frame portion and is configured to contact the air filter when installed in the air filter adapter and prevent the air filter from passing through the frame portion.

2. The air filter adapter of claim 1, wherein the first length differs from the second length and the first width differs from the second width.

3. The air filter adapter of claim 1, wherein the first length, the first width, the second length, and the second width are configured to extend a length and a width of the air filter to fit into an opening of an air handling system, and wherein the air filter is smaller than the opening.

4. The air filter adapter of claim 1, wherein the frame portion and the flange portion are formed of a plastic material.

5. The air filter adapter of claim 1, wherein a thickness of the frame portion corresponds to a thickness of the air filter plus a thickness of the flange portion.

6. The air filter adapter of claim 1, further comprising a compressible component positioned on an inner surface of the frame portion, the compressible component configured to compress when the air filter is installed within the air filter adapter.

7. The air filter adapter of claim 1, wherein the first side and second side comprise a telescoping component such that the first length is variable and the third side and the fourth side comprise a telescoping component such that the second length is variable.

8. The air filter adapter of claim 1, further comprising a securing component configured to secure against a first side of the air filter when the air filter is inserted into the air filter adapter with a second side of the air filter positioned adjacent the flange portion.

9. An air filter component comprising:
an air filter having a frame and a filter media; and
an air filter adapter including:
a frame portion including two sets of parallel sides, the two sets of parallel sides having a first thickness, wherein a first set of the two sets of parallel sides has a first width and a second set of the two sets of parallel sides has a second width; and
a flange portion extending towards a center of the frame portion and positioned at a first edge of the frame portion, wherein the air filter is removably inserted into the frame portion and secured in a first direction by the flange portion and secured along a first plane by the frame portion.

10. The air filter component of claim 9, wherein the air filter adapter is formed of a rigid material including at least one of a plastic, a rubber, a metal, or a composite.

11. The air filter component of claim 9, wherein the air filter adapter includes a compressible component on an exterior surface of the frame portion, the compressible component and exterior surface of the frame portion configured to interface with and seal against an opening of an air handling system.

12. The air filter component of claim 9, wherein an inner surface of the frame portion is tapered with respect to an outer surface of the frame portion.

13. The air filter component of claim 9, wherein the first width differs from the second width, and wherein the first set of the two sets of parallel sides has a first length different from a second length of the second set of the two sets of parallel sides.

14. The air filter component of claim 9, wherein a first width of the air filter plus a width of the first set of the two sets of parallel sides corresponds to a second width of an opening of an air handling system.

15. The air filter component of claim 14, wherein a first length of the air filter plus a width of the second set of the two sets of parallel sides corresponds to a second length of the opening of an air handling system.

16. The air filter component of claim 9, further comprising a compressible component positioned on an inner surface of the frame portion, the compressible component configured to compress when the air filter is installed within the air filter adapter.

17. The air filter component of claim 9, further comprising a securing component configured to secure against a first side of the air filter when the air filter is inserted into the air filter adapter with a second side of the air filter positioned adjacent the flange portion.

18. The air filter component of claim 9, wherein a thickness of the frame portion corresponds to a thickness of the air filter plus a thickness of the flange portion.

19. An air filter system comprising:
an air handling system configured to move air through a duct;
an air filter opening sized to receive an air filter having a first dimension and a second dimension; and
an air filter adapter having:
a frame portion including:
a first pair of opposite sides each having a first length and a first width;
a second pair of opposite sides each having a second length and a second width; and
a flange portion that extends at least partially from an inner perimeter of the frame portion, the flange portion having a third width and defining an inner opening, and wherein the flange portion is adjacent a bottom edge of the frame portion and is configured to contact an air filter when installed in the air filter adapter and prevent the air filter from passing through the frame portion.

20. The air filter system of claim 19, wherein the air filter adapter is formed of a plastic material.
